(19) United States
(12) Patent Application Publication
(10) Pub. No.: US 2013/0109447 A1
(43) Pub. Date: May 2, 2013

(54) MOBILE WIRELESS DEVICE

(71) Applicants: Akito Sakamoto, Kanagawa (JP); Kouta Aoki, Kanagawa (JP); Kenshi Horihata, Kanagawa (JP); Masashi Koshi, Ishikawa (JP); Takahiro Ochi, Miyagi (JP)

(72) Inventors: Akito Sakamoto, Kanagawa (JP); Kouta Aoki, Kanagawa (JP); Kenshi Horihata, Kanagawa (JP); Masashi Koshi, Ishikawa (JP); Takahiro Ochi, Miyagi (JP)

(73) Assignee: PANASONIC CORPORATION, Osaka (JP)

(21) Appl. No.: 13/703,548

(22) PCT Filed: Jul. 5, 2011
(86) PCT No.: PCT/JP2011/003844

§ 371 Date: Dec. 11, 2012

(30) Foreign Application Priority Data
Jul. 5, 2010 (JP) 2010-153434

(51) Int. Cl. H04M 1/02

(52) U.S. Cl. CPC H04M 1/0249
USPC 455/575.1

(57) ABSTRACT

A mobile wireless device includes a first housing, a second housing, a first hinge configured to freely openably and closably connect the first housing with the second housing, a third housing, a second hinge configured to freely pivotally connect the second housing with the third housing, a first circuit board provided in the first housing, a second circuit board provided in the second housing, a signal cable configured to electrically connect the first circuit board with the second circuit board and adapted to be inserted into a cylindrical portion of the second hinge, and a conductive element provided in the second housing. An end of the conductive element is connected to the second hinge, and the cylindrical portion of the second hinge is capacitively coupled to the signal cable.

### TECHNICAL FIELD

The invention relates, in general, to a mobile wireless device, such as a mobile phone, and more particularly, a foldable mobile wireless device having a two-axis rotation structure.

### BACKGROUND ART

Recently, in mobile wireless devices, such as mobile phones, a variety of different structures is proposed in terms of use or design ability. Among of them, a device is known in which a two-axis rotation structure (also referred as a “swivel structure”) is employed to take “a normally closed state” upon standby, “an opened state” upon making a call, and “a viewer closed state” closed to allow a screen to be seen upon receiving a one-segment broadcasting.

FIG. 8 shows perspective views of the exterior of a foldable mobile wireless device 100 with a two-axis rotation structure employed therein according to the related art. In this figure, FIG. 8(a) shows a normally closed state, FIG. 8(b) shows an opened state and FIG. 8(c) shows a viewer closed state. As shown in FIG. 8(b), the mobile wireless device 100 includes three housings (i.e., a first housing 101, a second housing 102, and a third housing 103). A first hinge (not shown) is provided on a connection portion between the first housing 101 and the second housing 102 and a second hinge (not shown) is provided on a connection portion between the second housing 102 and the third housing 103. The first housing 101 and the second housing 102 are freely openably and closably connected to each other via the first hinge and the second housing 102 and the third housing 103 are freely pivotally connected to each other via the second hinge.

In the mobile wireless device as described above, an internal or downsized antenna is demanded in terms of design ability, and a wideband antenna is also demanded because the antenna needs to correspond to a variety of frequencies in the domestic and foreign countries. Upon designing the internal antenna, it is important to ensure high antenna performance in both an opened state (the state shown in FIG. 8(b)) and a closed state (the normally closed state and the viewer closed state). As one method for ensuring high antenna performance in the closed state, a method is proposed in which a ground line is provided (see Patent Documents 1 and 2).

However, in the mobile wireless device as described above, when the first hinge is used as the antenna device or the antenna device is disposed near the first hinge and a housing length in the opened state corresponds to one wavelength of an frequency (e.g., an operation frequency of 1.5 GHz), electric currents in the first housing 101 and the third housing 103 in the closed state flow in opposing directions (i.e., negative-phase current), thereby deteriorating antenna performance.

Such a problem is described, by way of example, for the typical foldable mobile wireless device without the two-axis rotation structure employed therein according to the related art. FIG. 9 is a view showing a flow direction of electric current in each of a first housing 201 and a second housing 202 in a closed state of a typical foldable mobile wireless device without a two-axis rotation structure employed therein according to the related art. Also, the mobile wireless device shown in this figure does not have a ground line. The first housing 201 corresponds to the first housing 101 of the mobile wireless device 100 and the second housing 202 corresponds to the third housing 103 of the mobile wireless device 100. In FIG. 9, an electric current in the first housing 201 flows from a tip end to a base end of the first housing 201 as shown by an arrow A. In the second housing 202, an electric current flows from a base end to a tip end of the second housing 202 as shown by an arrow B. The electric current flowing in the first housing 201 and the electric current flowing in the second housing 202 are in opposing directions to be cancelled each other. As a result, the antenna performance is deteriorated.

On the other hand, FIG. 10 is a view showing a flow direction of electric current in each of the first housing 201 and the second housing 202 in the closed state of the mobile wireless device of FIG. 9, when a ground line 300 is provided. In this figure, an electric current flows in the ground line 300 as shown by an arrow C. Although the electric current flowing in the first housing 201 and the electric current flowing in the second housing 202 are in opposing directions to be cancelled each other, the ground current flows in the ground line 300, so that a distribution between the electric current flowing in the first housing 201 and the electric current flowing in the second housing 202 is changed, thereby reducing the cancelled electric current. As a result, the antenna performance is enhanced.

### CITATION LIST

### Patent Documents

[Patent Document 1] WO2006/112160
[Patent Document 1] WO2007/004499

### SUMMARY OF THE INVENTION

### Problems to be Solved by the Invention

However, although the antenna performance in the closed state can be enhanced by providing the ground line, a member for directly connecting the ground line to a ground adjacent thereto is required, and also a housing internal structure allowing the member to be provided is required, thereby leading to a problem in that the number of parts and costs are increased. In addition, when a sealed structure for providing a waterproof or dustproof function is required, it is difficult to implement a structure for directly connecting the ground line to a ground adjacent thereto. Otherwise, there are problems in that members, such as packings, are required to achieve the sealed structure, etc.

Accordingly, the present invention has been made keeping in mind the above problems, and an object of the present invention is to provide a foldable mobile wireless device employing a two-axis rotation structure, in which a structure for directly connecting a ground line to a ground to improve antenna performance is not required.

### Means for Solving the Problems

A mobile wireless device according to the present invention includes a first housing, a second housing, a first hinge configured to freely openably and closably connect the first housing with the second housing, a third housing, a second hinge configured to freely pivotally connect the second housing with the third housing, a first circuit board provided in the first housing, a second circuit board provided in the second housing, a signal cable configured to electrically connect the first circuit board with the second circuit board and adapted to be inserted into a cylindrical portion of the second hinge, and a conductive element provided in the second housing. An end of the conductive element is connected to the second hinge, and the cylindrical portion of the second hinge is capacitively coupled to the signal cable.

According to this configuration, the conductive element is connected to the second hinge using a capacitive coupling due to a stray capacitance between the cylindrical portion of the second hinge and the signal cable, so that the conductive element is high-frequency connected to a ground of the second circuit board. As a result, the conductive element can function as a ground line, thereby achieving high efficiency and wideband antenna performance. Also, a structure for directly connecting the conductive element to the ground is not required, and thus a cost increase caused by providing the conductive element can be limited to be low.

In the above configuration, the conductive element has an electrical length corresponding to approximately one-quarter of a wavelength of an operating frequency.

In the above configurations, an end of the conductive element is connected to the second hinge via a reactance element.

According to this configuration, the reactance element is provided between the conductive element as the ground line and the second hinge, so that the length of the conductive element can be reduced, thereby achieving downsizing thereof. In addition, a resonance frequency of the conductive element can be easily adjusted.

In the above configurations, the conductive element is disposed at a location which is not superimposed with the signal cable in viewed from the front. Specifically, the conductive element is disposed at a location which is not superimposed with metal parts, such as the signal cable or the second hinge, except a contact, when viewed from the front

According to this configuration, the conductive element is spaced apart from metal parts, thereby keeping high efficiency and wideband antenna performance.

In the above configurations, the conductive element is set so that an arm of the second hinge has a length corresponding to approximately one-quarter of a wavelength of an operating frequency.

According to this configuration, the arm of the second hinge can be used as the conductive element, and thus the number of parts and costs can be reduced.

### Advantageous Effects of the Invention

According to the present invention, enhancement in antenna performance of foldable mobile wireless devices employing a two-axis rotation structure can be achieved without unnecessary parts provided.

### BRIEF DESCRIPTION OF THE DRAWINGS

FIGS. 1(a) and 1(b) are perspective views showing the exterior of a mobile wireless device according to an embodiment 1 of the present invention.

FIG. 2 is a view showing a configuration of a connection portion between a second housing and a third housing in the mobile wireless device of FIG. 1.

FIG. 3 is a view showing a flow direction of electric current in each of a first housing and the third housing of the mobile wireless device of FIG. 1.

FIG. 4 is an explanatory view showing a variation in capacitance value of a stray capacitance depending on a difference between an inner diameter of a cylindrical portion of a second hinge and a diameter of a signal cable in the mobile wireless device of FIG. 1.

FIG. 5 is a view showing a configuration of a connection portion between a second housing and a third housing in a mobile wireless device according to an embodiment 2 of the invention.

FIG. 6 is a view showing a configuration of a connection portion between a second housing and a third housing in a mobile wireless device according to an embodiment 3 of the invention.

FIG. 7 is a view showing a structure in which a first hinge is used as an antenna device in the mobile wireless device of each of FIGS. 1, 5 and 6.

FIGS. 8(a) to 8(c) are perspective views showing the exterior of a foldable mobile wireless device with a two-axis rotation structure employed therein according to the related art

FIG. 9 is a view showing a flow direction of electric current in each of a first housing and a second housing in a closed state of a typical foldable mobile wireless device without a two-axis rotation structure employed therein according to the related art.

FIG. 10 is a view showing a flow direction of electric current in each of the first housing and the second housing in the closed state of the mobile wireless device of FIG. 9, when a ground line is provided.

### DESCRIPTION OF EMBODIMENTS

Preferred embodiments for implementing the present invention will be now described in detail with reference to the accompanying drawings.

### Embodiment 1

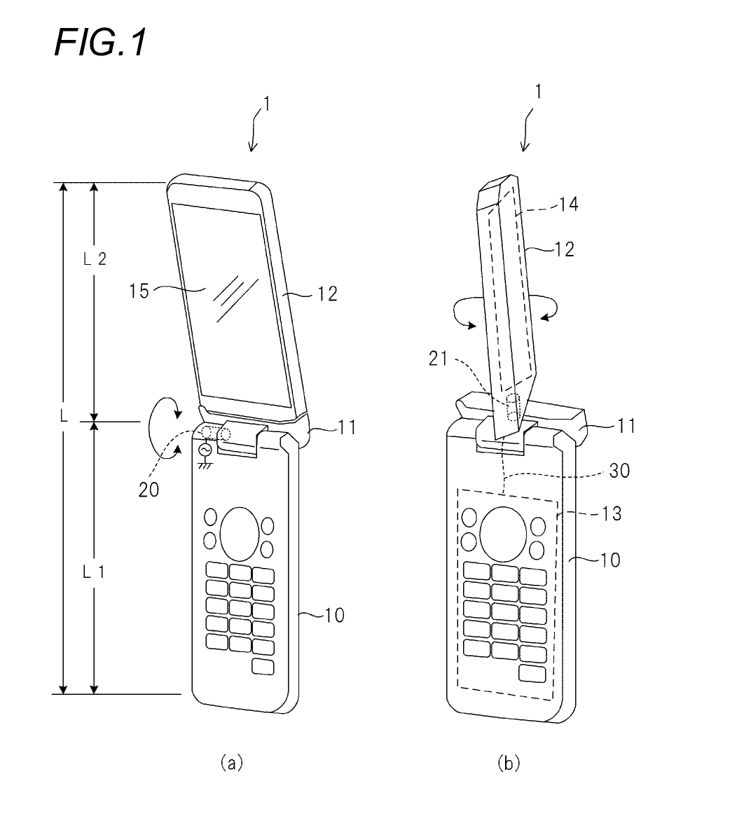

FIGS. 1(a) and 1(b) are perspective views showing the exterior of a mobile wireless device according to an embodiment 1 of the present invention. In this figure, the mobile wireless device 1 of the present embodiment is a foldable mobile wireless device employing a two-axis rotation structure and has three housings including a first housing 10, a second housing 11 and a third housing 13, the first housing 10 and the second housing 11 are freely openably and closably connected to each other via a first hinge 20, and the second housing 11 and the third housing 12 are freely pivotally connected to each other via a second hinge (i.e., a two-axis rotation hinge) 21. The first hinge 20 is provided between the first housing 10 and the second housing 11, and the second hinge 21 is provided between the second housing 11 and the third housing 12. The third housing 12 is provided with a liquid crystal display 15. Also, an antenna device (not shown) is disposed in the first housing 10.

Also, a first circuit board 13 is provided in the first housing 10 and a second circuit board 14 is provided in the third housing 12. The first circuit board 13 and the second circuit board 14 are connected to each other vie a signal cable 30. A fine-wire coaxial cable is used as the signal cable 30. The fine-wire coaxial cable is formed by arranging a plurality of fine wires in a cylindrical shape and then covering them with an outer conductor.

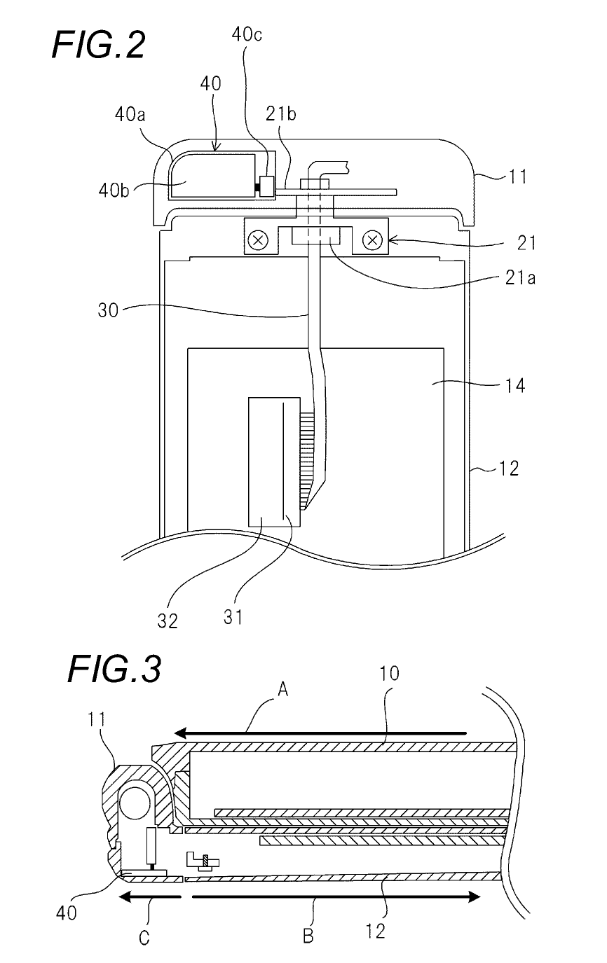

FIG. 2 is a view showing a configuration of a connection portion between the second housing 11 and the third housing 12 in the mobile wireless device 1 of the present embodiment. In FIG. 2, a connector 31 is connected to one end of the signal cable 30, and the connector 31 is connected to a connector 32 mounted on the second circuit board 14. Another identical connector 21 (not shown) is also connected to the other end of the signal cable 30 and the connector 31 is connected to a connector 32 (not shown) mounted on the first circuit board 13 in the first housing 10.

The second hinge 21 includes a cylindrical portion 21a having a through-hole penetrated to allow the signal cable 30 to be extended therethrough. The signal cable 30 is inserted into and through the cylindrical portion 21a of the second hinge 21, before the connector 31 is connected to at least one end thereof. A conductive element 40 is connected to an arm portion 21b of the second hinge 21 to function as a ground line. The conductive element 40 is constituted of a copper foil pattern 40b formed on a substrate 40a made of a glass epoxy resin and a contact 40c provided for connecting the copper foil patter 40b to the second hinge 21. Meanwhile, the conductive element 40 is not limited to the glass epoxy resin, but may be formed of a conductive metal sheet, a flexible printed circuit board or the like.

The conductive element 40 is disposed at a location which is not superimposed with metal parts, such as the signal cable 30 or the second hinge 21, except the contact 40c, when viewed from the front. The reason is that antenna performance is deteriorated when the conductive element 40 is disposed adjacent to the signal cable 30 or the second hinge 21. In order to prevent the deterioration of antenna performance, a constant space is kept between the conductive element 40 and the signal cable 30. Meanwhile, connection of the conductive element 40 to the second hinge 21 is obtained by connecting a connecting member attached to the arm portion 21b to the contact 40c.

An electrical length of the conductive element 40 is set to correspond to approximately one-quarter of a wavelength of an operating frequency in which a housing length (i.e., the entire length in an opened state as shown in FIG. 1(a)) L is approximately equal to one wavelength. Meanwhile, a length L1 of the first housing 10 and a length L2 of the second housing 11 is approximately equal to each other (L1≈L2).

The conductive element 40 is connected to a ground of the second circuit board 14 via the signal cable 30 by a capacitive coupling due to a stray capacitance between the cylindrical portion 21a of the second hinge 21 and the signal cable 30. In other words, the conductive element 40 is high-frequency connected to the ground of the second circuit board 14, using the capacitive coupling due to the stray capacitance between the cylindrical portion 21a of the second hinge 21 and the signal cable 30. By using the capacitive coupling due to the stray capacitance between the cylindrical portion 21a of the second hinge 21 and the signal cable 30, a member or a housing structure for directly connecting the conductive member 40 to the ground is not required, and thus the number of parts and costs can be reduced. A sealed structure for providing a waterproof or dustproof function is easily constructed. The reasons will be described with reference to FIG. 2. If the present invention is not employed, the arm portion 21b has firstly to be connected to the contact 40c by a conductive connecting member and then the second hinge 21 has to be connected to the ground in the third housing 12 by a conductive connecting member and the like, to directly connect the conductive element 40 to the ground. However, when the sealed structure for providing a waterproof function is implemented inside the third housing 12 by such a configuration, a packing member and the like are additionally required to achieve the sealed structure in the connecting member for connecting the second hinge 21 in a non-waterproofed region to the ground in a waterproofed region. In other words, by employing the present invention, the member for directly connecting the second hinge 21 to the ground within the third housing 12 is not required and also the packing and the like are not required. Because of the foregoing reasons, the sealed structure for providing a waterproof or dustproof function can be easily constructed according to the invention.

FIG. 3 is a view showing a flow direction of electric current in each of the first housing 10 and the third housing 12 in a closed state, when the conductive element 40 is provided. In this figure, an electric current in the first housing 10 flows from a tip end to a base end of the first housing 10 as shown by an arrow A, whereas an electric current in the third housing 12 flows from a base end to a tip end of the third housing 12 as shown by an arrow B. Also, for the third housing 12, an electric current flows in the conductive element 40 as shown by an arrow C. The electric current flowing in the first housing 10 and the electric current flowing in the third housing 12 are in opposing directions to be cancelled each other, but due to the electric current flowing in the conductive element 40, the antenna performance can be enhanced, compared to the case that the conductive element 40 is not provided.

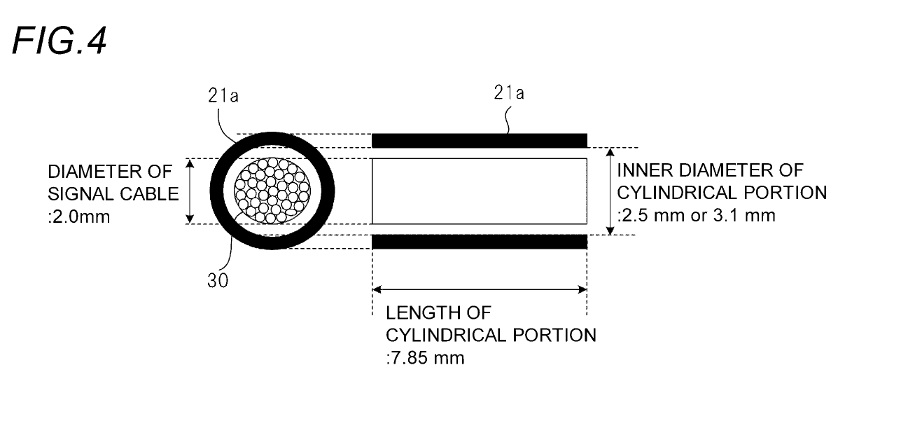

A capacitance value of the stray capacitance between the cylindrical portion 21a of the second hinge 21 and the signal cable 30 is varied depending on a difference between an inner diameter of the cylindrical portion 21a of the second hinge 21 and a diameter of the signal cable 30. It is important to design such that the capacitance value is as high as possible because the higher the capacitance value, the stronger the capacitive coupling is. FIG. 4 is an explanatory view showing a variation in capacitance value of the stray capacitance depending on the difference between the inner diameter of the cylindrical portion 21a of the second hinge 21 and the diameter of the signal cable 30. In this figure, when the diameter of the signal cable 30 is 2.0 mm, the inner diameter of the cylindrical portion 21a of the second hinge 21 is 2.5 mm, and a length of the cylindrical portion 21a is 7.85 mm, the capacitance value is 1.75 pF. Also, if the inner diameter of the cylindrical portion 21a of the second hinge 21 is 3.1 mm, the capacitance value is 0.82 pF. The smaller the difference between the inner diameter of the cylindrical portion 21a of the second hinge 21 and the diameter of the signal cable 30, the higher the capacitance value is. The difference is 0.25 mm when the inner diameter of the cylindrical portion 21a of the second hinge 21 is 2.5 mm, whereas the difference is 0.55 mm when the inner diameter is 3.1 mm.

As described above, according to the mobile wireless device 1 of the present invention, the conductive element 40 is connected to the second hinge 21 using the capacitive coupling due to the stray capacitance between the cylindrical portion 21a of the second hinge 21 and the signal cable 30, so that the conductive element 40 is high-frequency connected to the ground of the second circuit board 14. As a result, the conductive element 40 can function as a ground line, thereby achieving high efficiency and wideband antenna performance. Also, a structure for directly connecting the conductive element 40 to the ground is not required, and thus a cost increase caused by providing the conductive element 40 can be limited to be low and the number of parts can be reduced. Also, the sealed structure for providing a waterproof or dustproof function can be easily constructed

### Embodiment 2

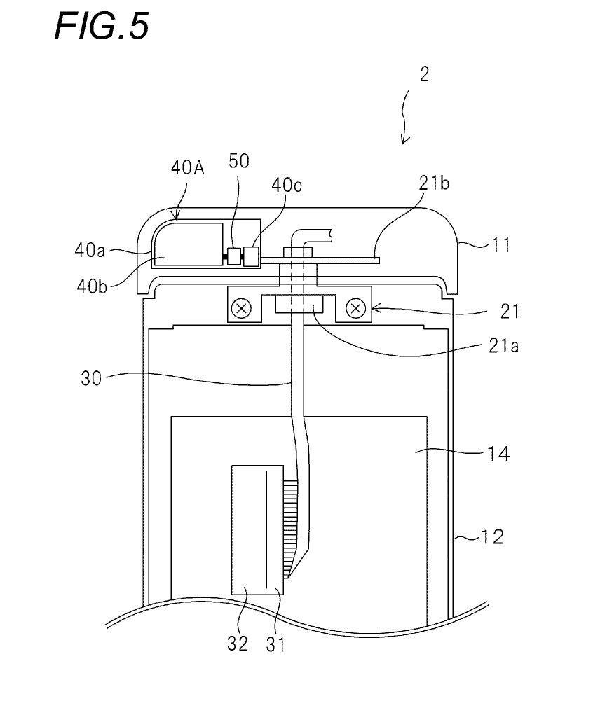

FIG. 5 is a view showing a configuration of a connection portion between a second housing and a third housing in a mobile wireless device according to an embodiment 2 of the present invention. The mobile wireless device 2 according to the present embodiment employs a two-axis rotation structure, like the mobile wireless device 1 of the foregoing embodiment 1. In FIG. 5, the same components as those of FIG. 1(a), FIG. 1(b) and FIG. 2 are designated by the same reference numerals. In the mobile wireless device 2 of the present embodiment, an antenna device not shown is also disposed in a first housing 10.

The mobile wireless device 2 of the present embodiment includes a conductive element 40A having a reactance element 50. The conductive element 40A has an end connected to an arm portion 21b of a second hinge 21 via the reactance element 50. Because the conductive element 40A has the reactance element 50, the entire length of the conductive element 40A is shorter than that of the conductive element 40 of the mobile wireless device 1 according to the foregoing embodiment 1, thereby achieving downsizing thereof. In addition, a resonance frequency of the conductive element 40A can be easily adjusted by changing a value of the reactance element 50.

### Embodiment 3

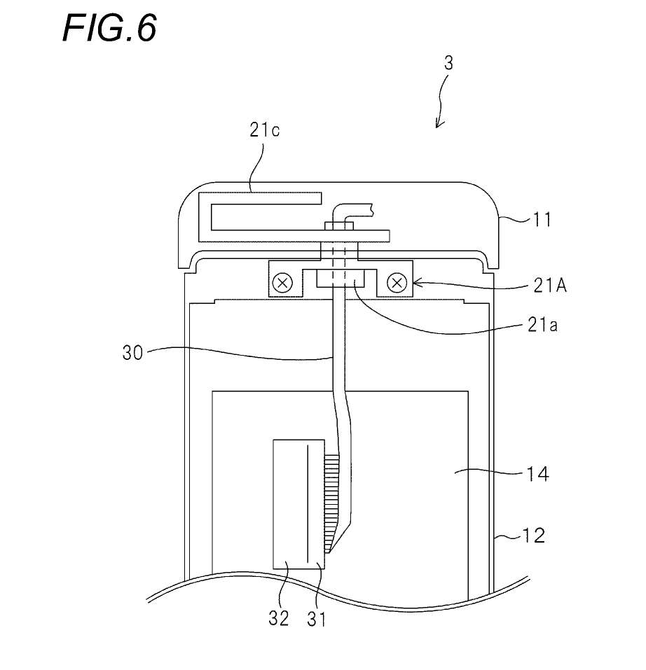

FIG. 6 is a view showing a configuration of a connection portion between a second housing and a third housing in a mobile wireless device according to an embodiment 3 of the present invention. The mobile wireless device 3 according to the present embodiment employs a two-axis rotation structure, like the mobile wireless device 1 of the foregoing embodiment 1. In FIG. 6, the same components as those of FIGS. 1(a), 1(b) and 2 are designated by the same reference numerals. In the mobile wireless device 3 of the present embodiment, an antenna device not shown is also disposed in a first housing 10.

The mobile wireless device 3 of the present embodiment includes a second hinge 21A having an arm portion 21c of which a length corresponds to approximately one-quarter of a wavelength of an operating frequency. By corresponding the length of the arm portion 21c of the second hinge 21A to approximately one-quarter of the wavelength of the operating frequency, it is possible for the arm portion 21c to function as a conductive element. As a result, a dedicated conductive element is not required, thereby reducing the number of parts and costs.

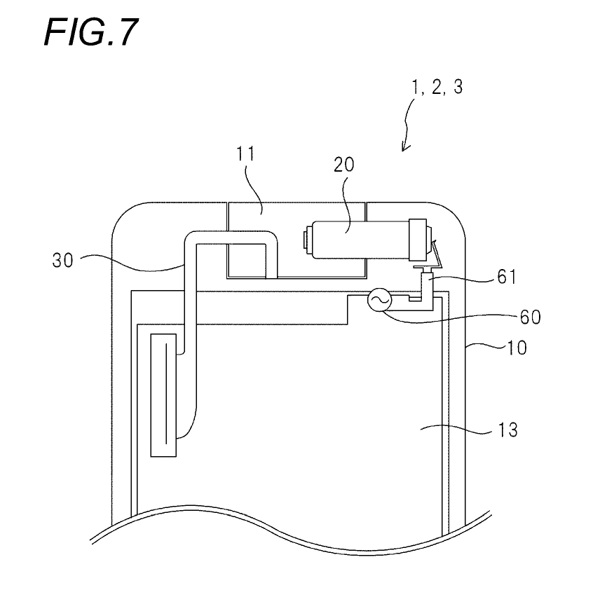

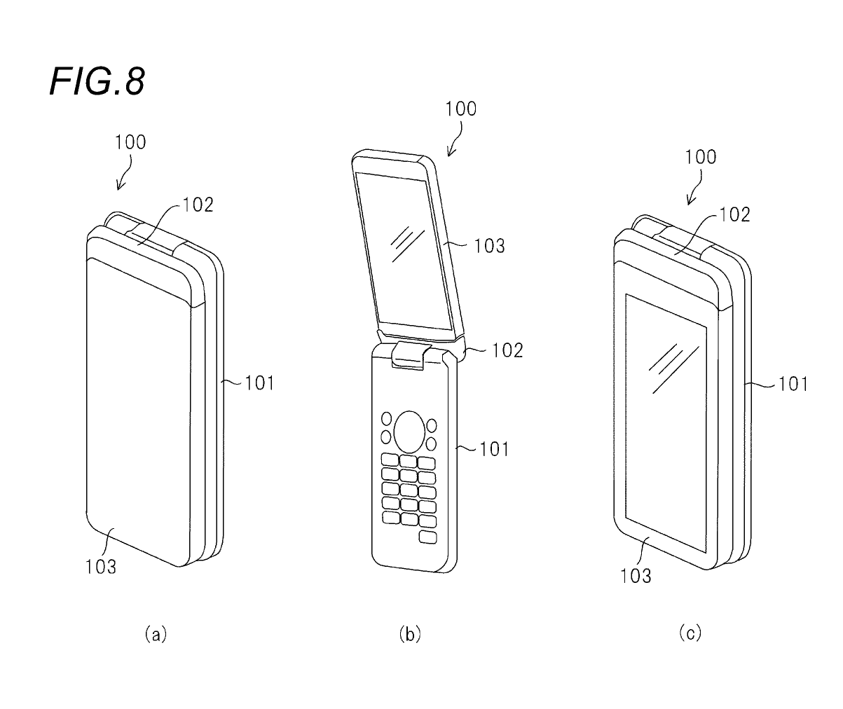

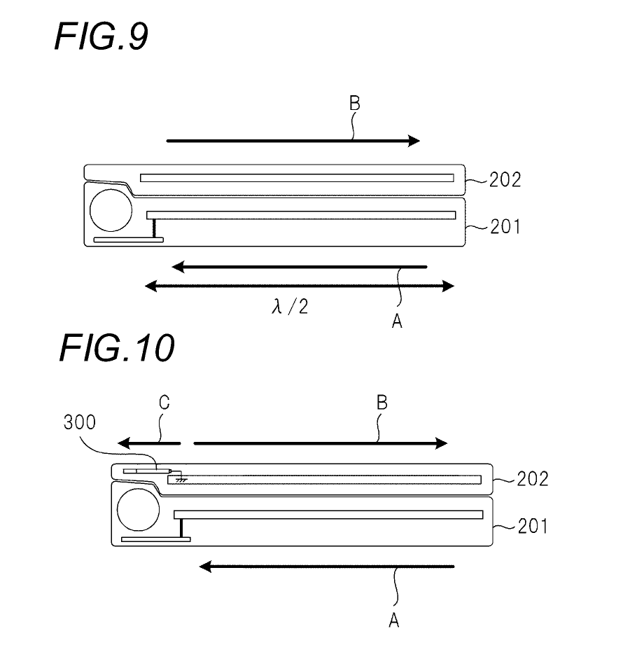

Meanwhile, although a dedicated antenna device not shown is disposed in the first housing 10 in the mobile wireless devices 1 to 3 of the foregoing embodiments 1 to 3, the dedicated antenna device is not provided, but the first hinge 20 may be used as an antenna device. FIG. 7 is a view showing a structure in which the first hinge 20 is used as the antenna device. An electric current is supplied from an electric current supplying portion 60 of the first circuit board 13 to the first hinge 20 via an electric current supplying sheet metal 61.

In addition, the conductive element 40 of the mobile wireless device 1 of the embodiment 1 and the conductive element 40A of the mobile wireless device 2 of the embodiment 2 can be also easily post-attached to a mobile wireless device which does not include a conductive element as a ground line.

Although the present invention has been described in detail and with reference to specific embodiments, it will be apparent by those skilled in the art that various changes and modifications may be made without departing from the spirit and scope of the invention.

This application is based on Japanese Patent Application (Japanese Patent Application No. 2010-153434) filed on Jul. 5, 2010, the entire contents of which are incorporated herein by reference.

### INDUSTRIAL APPLICABILITY

The present invention can be applied to mobile wireless devices, such as mobile phones, smart phones, and handheld game consoles.

### DESCRIPTION OF REFERENCE NUMERALS AND SIGNS

1, 2, 3 Mobile wireless device
10 First housing
11 Second housing
12 Third housing
13 First circuit board
14 Second circuit board
15 Liquid crystal display
20 First hinge
21, 21A Second hinge
21a Cylindrical portion
21b, 21c Arm portion
30 Signal cable
31, 32 Connector
40, 40A Conductive element
40a Substrate
40b Copper foil pattern
40c Contact
50 Reactance element
60 Electrical current supplying portion
61 Electrical current supplying sheet metal

1. A mobile wireless device comprising:
a first housing;
a second housing;
a first hinge configured to freely openably and closably connect the first housing with the second housing;
a third housing;
a second hinge configured to freely pivotally connect the second housing with the third housing;
a first circuit board provided in the first housing;
a second circuit board provided in the second housing;
a signal cable configured to electrically connect the first circuit board with the second circuit board and adapted to be inserted into a cylindrical portion of the second hinge; and
a conductive element provided in the second housing,
wherein an end of the conductive element is connected to the second hinge, and the cylindrical portion of the second hinge is capacitively coupled to the signal cable.

2. The mobile wireless device according to claim 1, wherein the conductive element has an electrical length corresponding to approximately one-quarter of a wavelength of an operating frequency.

3. The mobile wireless device according to claim 1, wherein an end of the conductive element is connected to the second hinge via a reactance element.

4. The mobile wireless device according to claim 1, wherein the conductive element is disposed at a location which is not superimposed with the signal cable in viewed from the front.

5. The mobile wireless device according to claim 1, wherein the conductive element is set so that an arm of the second hinge has a length corresponding to approximately one-quarter of a wavelength of an operating frequency.
